(19) United States
(12) Patent Application Publication
(10) Pub. No.: US 2004/0147247 A1
(43) Pub. Date: Jul. 29, 2004

(54) Compression method, transmitter and receiver for radio data communication

(76) Inventors: Cristian Demetrescu, Twickenham (GB); Colleen Yue Ling Cheung, Swindon (GB); Amardiya Sesmun, Swindon (GB); Gerry Foster, Swindon (GB)

Correspondence Address: FREESCALE SEMICONDUCTOR, INC., LAW DEPARTMENT, 7700 WEST PARMER LANE MD:TX32/PL02, AUSTIN, TX, 78729, US

(21) Appl. No.: 10/466,599

(22) PCT Filed: Feb. 5, 2002
(86) PCT No.: PCT/EP02/01328

(30) Foreign Application Priority Data
Feb. 7, 2001 (GB) 0103098.0

(51) Int. Cl. H04M 11/00

(52) U.S. Cl. 455/412.1; 455/403

(57) ABSTRACT

An SIP/SDP compression method, transmitter (510) and receiver (550) for communicating a message from the transmitter to the receiver by, at the transmitter, removing from the message element (s) thereof and inserting into the message an indication (200) of absence of the removed element (s); and, at the receiver, inserting into a message received from the transmitter element (s) pre-cached at the receiver in replacement for the element (s) whose absence is indicated. This provides a lightweight SIP/SPD compression scheme (LSSCS) that (i) removes the information redundancy generated at the application layer, and (ii) can achieve 100% compression efficiency for the redundant SIP and SDP URL fields.

### FIELD OF THE INVENTION

This invention relates to compression schemes used in radio data communications applications such as cellular telephony.

### BACKGROUND OF THE INVENTION

In the field of this invention it is known that in cellular radio communications systems, for example those based on the GSM (Global System for Mobile Communications) or UMTS (Universal Mobile Telecommunications System) standards, existing data compression algorithms act at the transport, network and link layers but they do not perform any compression above the transport layer. Existing compression algorithms perform binary compression, (i.e., removing redundancy in the bits included in each packet). Current data compression algorithms compress only the packet headers used at each layer while other algorithms perform binary compression of the data payload.

However, this approach has the disadvantage(s) that binary compression is limited because it does not remove the information redundancy generated at the application layer. Binary compression also increases the packet processing time especially when it is done hop-by-hop which is the case with most header compression algorithms. For example, in UMTS the packet data convergence protocol (PDCP) performs only binary header compression and no payload compression. This limits the compression efficiency that can be achieved.

A need therefore exists for a compression scheme for radio data communications wherein the abovementioned disadvantage(s) may be alleviated.

### STATEMENT OF INVENTION

In accordance with a first aspect of the present invention there is provided a method of communicating a message from a transmitter to a receiver in a data communication system using Session Initiation Protocol and Session Description Protocol (SIP/SDP) as claimed in claim 1.

In accordance with a second aspect of the present invention there is provided a transmitter for use in communicating a message therefrom to a receiver in a data communication system using Session Initiation Protocol and Session Description Protocol (SIP/SDP) as claimed in claim 7.

In accordance with a third aspect of the present invention there is provided a receiver for receiving a message from a transmitter in a data communication system using Session Initiation Protocol and Session Description Protocol (SIP/SDP) as claimed in claim 12.

### BRIEF DESCRIPTION OF THE DRAWINGS

One Session Initiation Protocol (SIP)/Session Description Protocol (SDP) compression scheme incorporating the present invention will now be described, by way of example only, with reference to the accompanying drawing(s), in which:

FIG. 1 shows a block diagram of a protocol stack for for use in the compression scheme;

FIG. 2 shows a block diagram of a header for use in the compression scheme;

FIG. 3 shows a block diagram of an encapsulated SIP/SDP Message for use in the compression scheme; and

FIG. 4 shows a schematic diagram of an example of pre-cache procedure for use in the compression scheme within a UMTS system;

FIG. 5 shows a block schematic diagram of a UMTS radio communication system including a transmitter and a receiver for implementing the compression scheme of FIG. 1-FIG. 4.

### DESCRIPTION OF PREFERRED EMBODIMENT

Session Initiation Protocol (SIP) is one of the candidates used for multimedia call control signalling. The present invention proposes use of the SIP protocol together with the session description protocol (SDP) in a lightweight compression scheme. The current SIP message size could be in excess of 1000 bytes due to its textual HTTP encoding. This is, for example, the case of a SIP message containing a Record-Route header field. In this case the SIP message will pick up the Request-URLs of all the SIP servers on the path of this message, therefore leading to a large SIP message size (unlimited in theory). Also the SIP URL encoding contains many header extensions and options, which could increase the SIP message size.

While the large SIP message size might not be a problem for networks with plenty of bandwidth available, this is not the case for many access networks. For example wireless access networks (e.g. UMTS, GSM) have scarce bandwidth and therefore the transmission of current SIP messages over the air interface is not efficient. Also the low-end modems used to connect computers (particularly laptop computers) to the Internet have the same problem due to bandwidth shortage. In all these cases the transmission of SIP messages in the current format will render long call set up times and inefficient use of the transmission medium.

The present invention proposes a new Lightweight SIP/SDP Compression Scheme (LSSCS), which will be described in detail below, which allows these disadvantages to be alleviated or overcome.

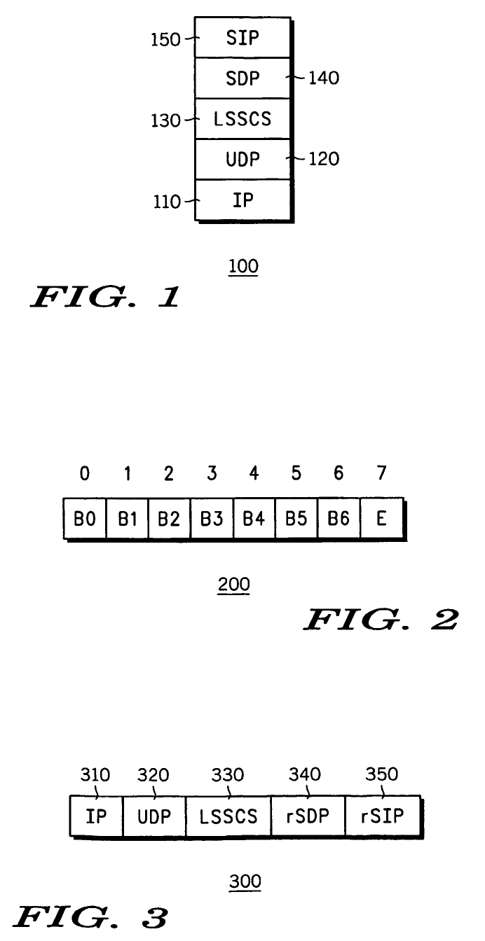

A User Datagram Protocol/Internet Protocol (UDP/IP) protocol stack for use with LSSCS is shown in FIG. 1. It will be understood that the UDP/IP stack illustrated in FIG. 1 is only for example purposes and does not restrict the applicability of the LSSCS with any other transport/network layers.

As shown in FIG. 1, the UDP/IP stack 100 includes successive layers of internet protocol (IP) 110, User Datagram Protocol (UDP) 120, Lightweight SIP/SDP Compression Scheme (LSSCS) 130, Session Description Protocol (SDP) 140 and Session Initiation Protocol (SIP) 150.

The packet overhead introduced by the LSSCS layer 130 is shown in FIG. 2.

As shown in FIG. 2, the LSSCS header 200 is a 8-bit byte in which bits 0-6 (B0-B6) are data bits, and bit 7 is an extension (E) bit. Each data bit B0-B6 in the LSSCS header points to a field in either the SIP or the SDP messages. The LSSCS header is octet aligned (i.e., comprises an integer number of octets). If the extension bit is set to 1 then another LSSCS header octet is added to the LSSCS header. When E=0 then no extension header is added. As SIP/SDP messages have extension and option fields, the LSSCS header is flexible, and can therefore cover all possible message formats.

The meaning of the bits B0 to B6 is as follows. Assuming that the bit Bn addresses a particular field in the SIP/SDP message, and indicates the presence or absence that particular field in the SIP/SDP message, as follows:

Bn=1 indicates that the corresponding SIP/SDP field is present in the SIP/SDP message, or

Bn=0 indicates that the corresponding SIP/SDP field is removed from the SIP/SDP because it is redundant. In this case the LSSCS receiver can recover the removed field by using additional information already available.

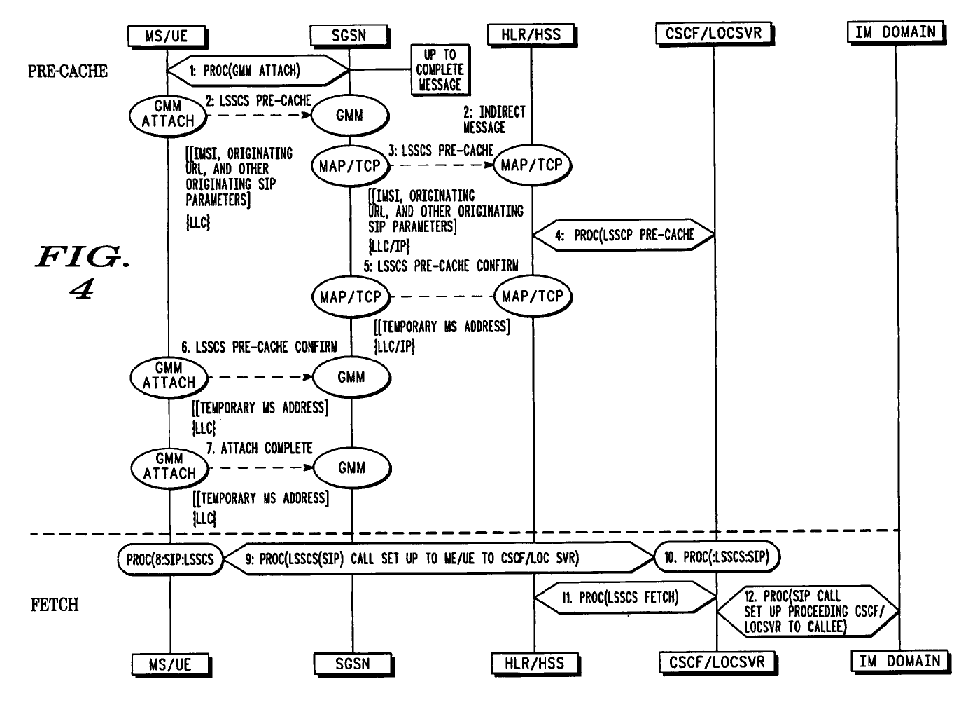

Assuming the protocol stack shown in FIG. 1, the LSSCS encapsulated SIP/SDP message is shown in FIG. 3, where IP (310) is the IP Header, UDP (320) is the UDP header, LSSCS (330) is the LSSCS header (including any extensions), and rSDP (340) and rSIP (350) are the reduced SDP and SIP messages respectively.

It is proposed that upon first registering of a mobile terminal with the call control state function (CSCF), the mobile terminal obtains a table, which provides a mapping of the CSCF's association of bits in the LSSCS header to a corresponding SIP/SDP field. Alternatively, this table may be standardised with an industry-accepted standardised mapping of the SIP/SDP fields to the individual LSSCS header bits.

An example of a possible mapping is shown in Table 1 below:

TABLE 1
LSSCS - SIP/SDP Mapping Information

| LSSCS header bits | SIP/SDP fields |
|---|---|
| B0 | From |
| B1 | To |
| B2 | Call-ID |
| B3 | Content-Type |
| B4 | Via |
| B5 | Session Name |
| B6 | Session and Media |
| | Information |

Referring to the above table, if B0=0, B1=1, B2=0, B3=0, B4=0, B5=1, B6=1, the CSCF is then able to understand from the LSSCS header that the rSIP and rSDP messages from the mobile terminal are as below, assuming the message is an INVITE message:

| | |
|---|---|
| INVITE sip:schooler@vlsi.caltech.edu SIP/2.0 | |
| To: sip:schooler@cs.caltech.edu | rSIP message |
| s = Mbone Audio | rSDP message |
| i = Discussion of Mbone Engineering Issues | |

This is the compressed SIP/SDP message. The CSCF also then reconstructs the message providing mandatory SIP and SDP fields, and providing any optional fields that it is able to obtain information on. The complete uncompressed message sent from the CSCF is then:

| | |
|---|---|
| INVITE sip:schooler@vlsi.caltech.edu SIP/2.0 | |
| From: sip:mjh@isi.edu | SIP message |
| To: sip:schooler@cs.caltech.edu | |
| Call-ID: 62729-27@128.16.64.19 | |
| Content-Type: application/sdp | |
| Via: SIP/2.0/UDP/128.16.64.19 | |
| s = Mbone Audio | SDP message |
| i = Discussion of Mbone Engineering Issues | |

It is clear that the compressed SIP/SDP message is much smaller than the original uncompressed message.

Pre-Caching Techniques Used in LSSCS

The LSSCS compression efficiency depends on the amount of information removed from a SIP/SDP message. This, in turn depends on the possibility of reconstructing the missing information from the pre-cached information stored. In some cases, a 10-fold reduction in the SIP/SDP message size can be achieved. Further compression efficiency can be achieved by using the lower layer compression algorithm together with LSSCS.

Other network entities and protocol layers provide the pre-cached information used by the LSSCS receiver to reconstruct the original SIP/SDP message. In the context of a UMTS network, the user equipment (UE) and the call control state function (CSCF) will implement the LSSCS. The callee/caller URL can be reconstructed by using the IP destination/source addresses respectively and therefore they can be removed from the SIP messages. An example of a pre-cache procedure within the UMTS system is shown in FIG. 4.

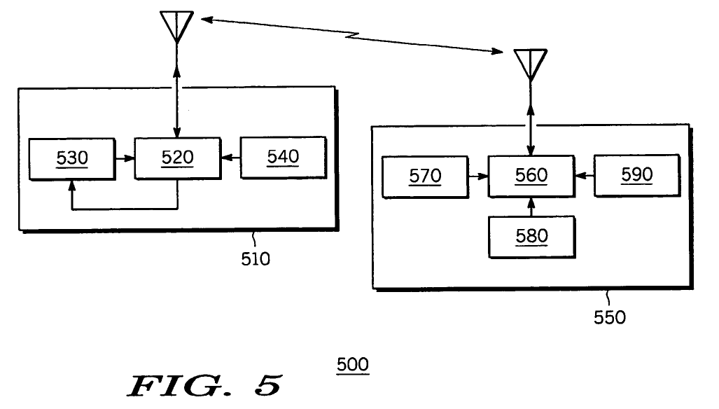

Referring now also to FIG. 5, a system 500 for implementing the SIP/SDP compression scheme described above, includes a transmitter in the form of mobile user equipment (UE) 510 and a receiver in the form of a UMTS Radio Network Controller (RNC) 550. The UE is controlled by a processor 520 and the RNC is controlled by a processor 560. The RNC 550 holds a mapping table 570 of correspondence between header bits and message elements that are redundant (such as the table 1 described above) which it communicates to the UE 510 when the UE 510 first registers with the RNC. The UE 510 stores the received mapping table in a memory 530.

When the UE 510 wishes to communicate a message 540 to the RNC 550, it first removes from the message any element that is indicated in the stored mapping table 530 and constructs a header (such as that shown in FIG. 2) indicating which elements of the original message have been removed. The UE 510 then transmits the compressed message together with the header in the encapsulated form shown in FIG. 3.

When the compressed message is received at the RNC 550, the RNC compares the header indicating absent information with the mapping table 570 and re-inserts into the compressed message the indicated, absent, redundant information which it already has pre-cached in store 580. Thus, the RNC re-constructs the original message 590.

Thus, in summary, it will be understood that LSSCS is a new compression algorithm located at the application layer and acting on the SIP/SDP message content. LSSCS may be considered a lightweight compression algorithm as it only adds a small extendable byte-aligned header to the reduced SIP/SDP message.

It will be understood that with LSSCS and its associated Pre-Cache/Fetch procedures operational, over-air SIP call set up times can be considerably reduced, making SIP cost effective for operation over a 3GPP radio interface and comparable in performance to a 3GPP 24.008 CC based call.

It will be further appreciated that with LSSCS packet voice calls become a cost effective alternative to circuit-switched ones, reducing the need for partnerships between system suppliers and switch suppliers and the need to provide two separate domain interfaces towards the 3GPP RNC/BSC.

It will be understood that LSSCS does not modify in any way the SIP and SDP protocols. Both the receiver and the transmitter of the SIP messages implement standard SIP and SDP protocols, so requiring minimal standardisation effort required.

Thus, it will be appreciated that:

LSSCS introduces a radical process to reduce substantially the SIP/SDP URL.

LSSCS uses pre-cached information from different networks entities (e.g. SIP location server, DNS server, Media Gateway, Security Server and DHCP server) as well as from other protocol entities (e.g. UDP/IP, IP routing and Mobility Management). The LSSCS caches this information locally and uses it to process the SIP/SDP messages. Examples of precached information are shown below.

LSSCS can be used independently of the other compression algorithms used at the lower layers of the protocol stack. The compression algorithms can be switched on and off at each protocol layer independently and any combination of them is possible. For example, one can use both LSSCS at the application layer and any UDP/IP compression scheme at the PDCP layer in UMTS, achieving an even better compression efficiency.

LSSCS compression is done only end-to-end as opposed to hop-by-hop compression schemes. Therefore LSSCS is a lightweight compression algorithm which requires little additional packet processing power and only at the end points.

In conclusion, it will be appreciated that the SIP/SDP compression scheme described above provides the following advantages:

LSSCS removes information redundancy generated at the application layer.

LSSCS can achieve 100% compression efficiency for the redundant SIP and SDP URL fields. The redundant information is removed at the transmitter and regenerated by the receiver using pre-cached information.

1. A method of communicating a message from a transmitter to a receiver in a data communication system using Session Initiation Protocol and Session Description Protocol (SIP/SDP), the method comprising the steps of:
at the transmitter, removing from the message at least one element thereof and inserting into the message an indication of absence of the at least one removed element; and
at the receiver, inserting into a message received from the transmitter at least one element held at the receiver in replacement for the at least one element whose absence is indicated.

2. The method as claimed in claim 1 wherein the indication of absence comprises a binary header in which at least one bit indicates the presence/absence of the at least one element.

3. The method as claimed in claim 1 or 2 wherein the indication of absence further comprises an indication of whether a further indication of absence indicates the absence of at least one further element.

4. The method as claimed in claim 1, 2 or 3 further comprising the step of, before transmission of the message from the transmitter, pre-caching at the receiver at least one element of the message.

5. The method as claimed in any preceding claim further comprising the step of, before transmission of the message from the transmitter, receiving at the transmitter a predetermined table of mapping between elements of messages and indications of absence thereof.

6. The method as claimed in any preceding claim wherein the data communication system is a UMTS system.

7. A transmitter for use in communicating a message therefrom to a receiver in a data communication system using Session Initiation Protocol and Session Description Protocol (SIP/SDP), the transmitter comprising: of:
means for removing from the message at least one element thereof; and
means for inserting into the message an indication of absence of the at least one removed element.

8. The transmitter as claimed in claim 7 wherein the indication of absence comprises a binary header in which at least one bit indicates the presence/absence of the at least one element.

9. The transmitter as claimed in claim 7 or 8 wherein the indication of absence further comprises an indication of whether a further indication of absence indicates the absence of at least one further element.

10. The transmitter as claimed in claim 7, 8 or 9 further comprising means for receiving, before transmission of the message therefrom, a predetermined table of mapping between elements of messages and indications of absence thereof.

11. The transmitter as claimed in any one of claims 7-10 wherein the data communication system is a UMTS system.

12. A receiver for receiving a message from a transmitter in a data communication system using Session Initiation Protocol and Session Description Protocol (SIP/SDP), the receiver comprising:
at the receiver, means for receiving from the transmitter a message including an indication of absence of at least one element from the received message; and means for inserting into the received message at least one element held at the receiver in replacement for the at least one element whose absence is indicated.

13. The receiver as claimed in claim 12 wherein the indication of absence comprises a binary header in which at least one bit indicates the presence/absence of the at least one element.

14. The receiver as claimed in claim 12 or 13 wherein the indication of absence further comprises an indication of whether a further indication of absence indicates the absence of at least one further element.

15. The receiver as claimed in claim 12, 13 or 14 further comprising means for, before transmission of the message from the transmitter, pre-caching at the receiver at least one element of the message.

16. The receiver as claimed in any one of claims 12-15 further comprising means for sending to the transmitter, before transmission of the message therefrom, a predetermined table of mapping between elements of messages and indications of absence thereof.

17. The receiver as claimed in any one of claims 12-16 wherein the data communication system is a UMTS system.

18. A method of communicating a message from a transmitter to a receiver in a data communication system substantially as herein before described with reference to the accompanying drawings.

19. A transmitter for use in communicating a message therefrom to a receiver in a data communication system substantially as herein before described with reference to the accompanying drawings.

20. A receiver for receiving a message from a transmitter in a data communication system substantially as herein before described with reference to the accompanying drawings.
